(19) United States
(12) Patent Application Publication
(10) Pub. No.: US 2017/0147931 A1
(43) Pub. Date: May 25, 2017

(54) METHOD AND SYSTEM FOR VERIFYING RULES OF A ROOT CAUSE ANALYSIS SYSTEM IN CLOUD ENVIRONMENT

(71) Applicant: HITACHI, LTD., Tokyo (JP)

(72) Inventors: Krishnaji DESAI, Bangalore (IN); Pranay VERMA, Bangalore (IN); Shubham CHITRANSHI, Bangalore (IN)

(73) Assignee: HITACHI, LTD., Tokyo (JP)

(21) Appl. No.: 15/357,095

(22) Filed: Nov. 21, 2016

(30) Foreign Application Priority Data
Nov. 24, 2015 (IN) 6303/CHE/2015

(51) Int. Cl. G06N 5/04

(52) U.S. Cl. CPC G06N 5/046

(57) ABSTRACT

The present disclosure relates to a method and a system for verifying one or more rules of a root cause analysis system in a cloud environment. In one embodiment, the method receives an input comprising predefined set of the one or more rules from a cloud database. The method further receives dynamically, information associated with one or more topologies of the cloud environment from the cloud database and one or more user inputs on the input. The method further verifies the input with the information associated with the one or more topologies of the cloud environment and the one or more user inputs, for determining compliance of one of the input and the information associated with the one or more topologies of the cloud environment with one or more property parameters. Upon verifying, the method generates a verification report.

### FIELD OF THE DISCLOSURE

The present subject matter is related, in general to a cloud environment and more particularly, but not exclusively to a method and a system for verifying rules of a root cause analysis system in the cloud environment.

### BACKGROUND

Generally, Cloud computing is a model for enabling ubiquitous, convenient, on-demand access to a shared pool of configurable computing resources. Cloud computing and other online services enable customers with various capabilities to store and process their data in third-party data centres. Since the customers rely on the cloud service providers, they expect the services provided by the cloud service providers to be continuous and fault resilient. However, it is not possible to provide 100% accurate cloud services continuously without any faults. Further, identifying root cause for the fault occurred in the cloud environment is also difficult to achieve due to increasing complexity in the cloud environment. Conventionally, Root Cause Analysis (RCA) systems are used to evaluate the root cause of the fault occurred. However, they are not reliable because the root cause evaluated is either incorrect or missing valid properties. The main reason behind evaluating unreliable root cause by the RCA system is incorrect rules given as input to the RCA system.

Typically, rules are verified to avoid incorrect rules given as input to the RCA system. Conventional verification methods verify the piles by deploying the rules into various models and evaluating their correctness. Other conventional methods verify properties of the rules using constraints and use predicate or transition models to determine the correctness of the rules and missing properties of the rules. However, the conventional verification methods cannot be utilized to verify the rules applicable to the RCA system for a continuously growing large scale cloud environment having huge complexity.

Therefore, there is a need for a method and a system for dynamically verifying the input rules based on the dynamically expanding topology of the cloud environment to deduce a correct root cause for the fault occurring in the growing cloud environment and overcoming the limitations of the existing methods.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Accordingly, the present disclosure relates to a method for verifying one or more rules of a root cause analysis system in a cloud environment. The method comprises of receiving by a rules verification system, an input comprising predefined set of the one or more rules from a cloud database. Upon receiving the input, the method comprises receiving dynamically by the rules verification system, information associated with one or more topologies of the cloud environment from the cloud database and one or more user inputs on the input comprising predefined set of the one or more rules. The method further comprises verifying by the rules verification system, the input comprising predefined set of the one or more rules with the information associated with the one or more topologies of the cloud environment and the one or more user inputs, for determining compliance of one of the input comprising predefined set of the one or more rules and the information associated with the one or more topologies of the cloud environment with one or more property parameters. Upon verifying, the method comprises generating by the rules verification system, a verification report comprising output verified result set of the one or more rules, a corresponding verification status information of each of the one or more rules of the output verified result set and a verification score determined for the output verified result set.

Further, the present disclosure relates to a rules verification system for verifying one or more rules of a root cause analysis system in a cloud environment. The system comprises a processing unit and a memory unit communicatively coupled to the processing unit, wherein the memory unit stores the processing unit-executable instructions which, on execution, causes the processing unit to receive an input comprising predefined set of the one or more rules from a cloud database. The processing unit is furthermore configured to receive dynamically information associated with one or more topologies of the cloud environment from the cloud database and one or more user inputs on the input comprising predefined set of the one or more rules. The processing unit further verifies the input comprising predefined set of the one or more rules with the information associated with the one or more topologies of the cloud environment and the one or more user inputs, for determining compliance of one of the input comprising predefined set of the one or more rules and the information associated with the one or more topologies of the cloud environment with one or more property parameters. Upon verifying, the processing unit generates a verification report comprising output verified result set of the one or more rules, a corresponding verification status information of each of the one or more rules of the output verified result set and a verification score determined for the output verified result set.

Furthermore, the present disclosure relates to a non-transitory computer readable medium including instructions stored thereon that when processed by at least one processing unit cause a rules verification system to perform the act of receiving an input comprising predefined set of the one or more rules from a cloud database. Further the instructions cause the processing unit to receive dynamically information associated with one or more topologies of the cloud environment from the cloud database and one or more user inputs on the input comprising predefined set of the one or more rules. Furthermore, the instructions cause the processing unit to verify the input comprising predefined set of the one or more rules with the information associated with the one or more topologies of the cloud environment and the one or more user inputs, for determining compliance of one of the input comprising predefined set of the one or more rules and the information associated with the one or more topologies of the cloud environment with one or more property parameters. Upon verifying, the instructions cause the processing unit to generate a verification report comprising output verified result set of the one or more rules, a corresponding verification status information of each of the one or more rules of the output verified result set and a verification score determined for the output verified result set.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an architecture diagram of an exemplary system for verifying one or more rules of a root cause analysis system in a cloud environment in accordance with some embodiments of the present disclosure;

FIG. 2a illustrates a detailed block diagram of a rules verification system for verifying one or more rules of a root cause analysis system in the cloud environment of FIG. 1 in accordance with some embodiments of the present disclosure:

FIGS. 2b-2g illustrate exemplary diagrams to show the process of verification of one or more rules with respect to one or more parameters in accordance with some embodiments of the present disclosure;

FIG. 3 illustrates a flowchart of an exemplary method for verifying one or more rules of a root cause analysis system in a cloud environment in accordance with some embodiments of the present disclosure; and

FIG. 4 is a block diagram of an exemplary computer system for implementing embodiments consistent with the present disclosure;

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to a method and a system for verifying one or more rules of a root cause analysis system (RCA) in a cloud environment. A rules verification system receives an input comprising predefined set of the one or more rules from a cloud database. Upon receiving the input comprising the predefined set of the one or more rules, the rules verification system receives dynamically, information associated with one or more topologies of the cloud environment from a cloud database and also receives one or more user inputs on the input comprising predefined set of the one or more rules. Further the rules verification system verifies the input comprising predefined set of the one or more rules with the information associated With the one or more topologies of the cloud environment and the one or more user inputs, for determining compliance of one of the input comprising predefined set of the one or more rules and the information associated with the one or more topologies of the cloud environment with one or more parameters. The one or more parameters may include, but not limited to, correctness, incorrectness, redundancy, completeness, incompleteness, consistency, inconsistency, satisfactory and non-satisfactory with respect to the input comprising predefined set of the one or more rules in accordance with the information associated with the one or more topologies of the cloud environment. Upon verification, a verification report is generated which comprises the output verified result set of the one or more rules. The verification report also comprises a corresponding verification status information of each of the one or more rules of the output verified result set of the one or more rules and a verification score determined for the output verified result set. The user performs one or more actions on at least one of the output verified result set and the information associated with the one or more topologies of the cloud environment, based on one or more suggestions provided by the rules verification system in accordance with the verification report. Upon performing the one or more actions by the user, the verification process continues till a correct output verified result set is obtained. The correct output verified result set is then given as an input to the RCA to deduce the root cause of a failure in the cloud environment.

Verifying the input comprising predefined set of the one or more rules with the information associated with one or more topologies of the cloud environment improves accuracy and reliability in deducing the root cause of the failure occurring in the cloud environment. Further, performance of the RCA system increases, resulting in efficient management of the cloud environment. Integrating the present disclosure in cloud administration provides solutions for several information technology (IT) operations. Further, the present disclosure provides optimal usage of resources and leads to fast resolution of failures in the cloud environment resulting in effective cost savings. Also, the verification effort is reduced as the verification with respect to the information associated with the one or more topologies of the cloud environment is performed before expansion of the one or more rules.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

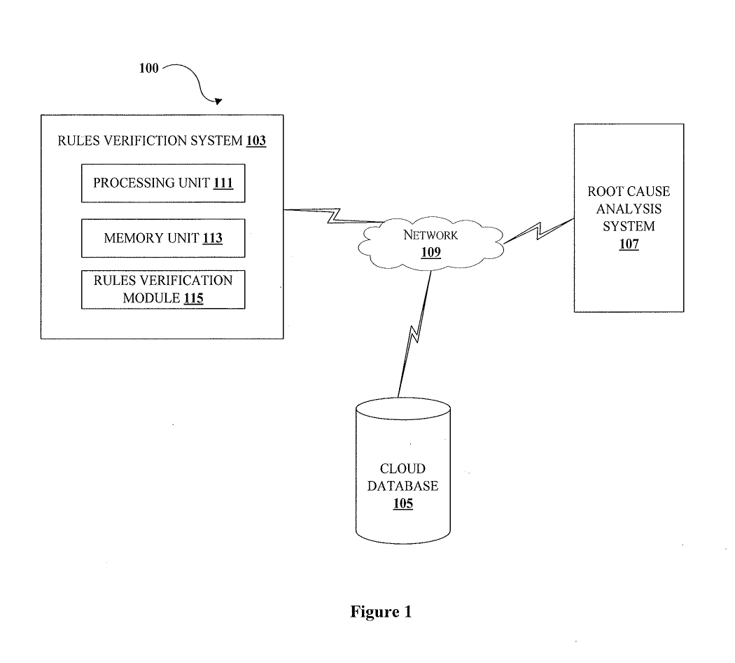

FIG. 1 illustrates an architecture diagram of an exemplary system for verifying one or more rules of a root cause analysis system in a cloud environment in accordance with some embodiments of the present disclosure.

As shown in FIG. 1, the exemplary system 100 comprises one or more components configured to verify one or more rules of a root cause analysis system 107 in a cloud environment. The one or more rules indicate correlation of one or more events with one or more root causes defined. The one or more root causes are defined based on corresponding properties and constraints associated with the one or more events and information associated with one or more topologies of the cloud environment. In one embodiment, the exemplary system 100 comprises a rules verification system 103, a cloud database 105 and a root cause analysis system 107 connected to each other via communication network 109. As an example, the communication network 109 may include, but not limited to, wireless communication network and wired communication network. The rules verification system 103 verifies the one or more rules of the root cause analysis system 103 in the cloud environment in accordance with the information associated with the one or more topologies of the cloud environment and one or more user inputs. The information associated with the one or more topologies of the cloud environment is retrieved dynamically from the cloud database 105. The cloud database 105 also stores large amount of other information related to the cloud environment. In one embodiment, the cloud database 105 may be integrated within the rules verification system 103. In another embodiment, the cloud database maybe implemented independent of the rules verification system 103. Upon verification of the one or more rules, a verification report is generated which comprises output verified result set of the one or more rules, a corresponding verification status information of each of the one or more rules of the output verified result set and a verification score determined for the output verified result set. The root cause analysis system 107 receives the output verified result set of the one or more rules generated by the rules verification system 103 as an input and processes the received input to deduce the root cause of a failure in the cloud environment.

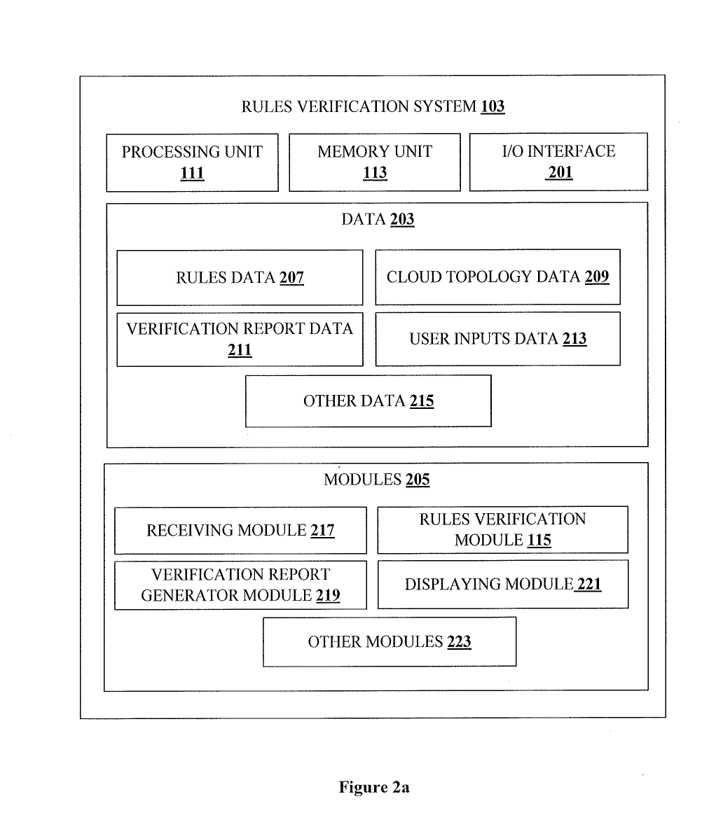

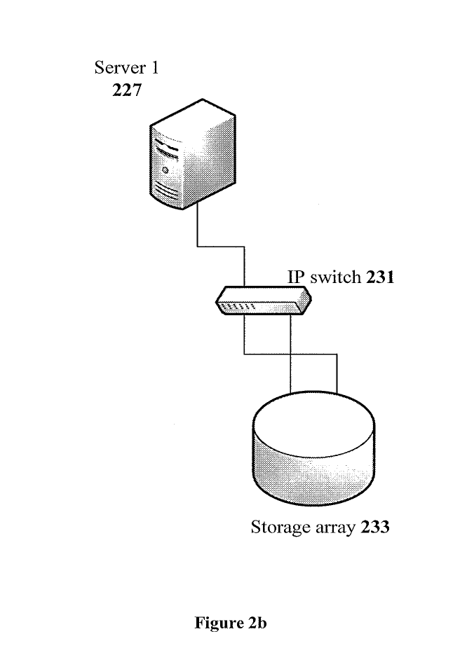

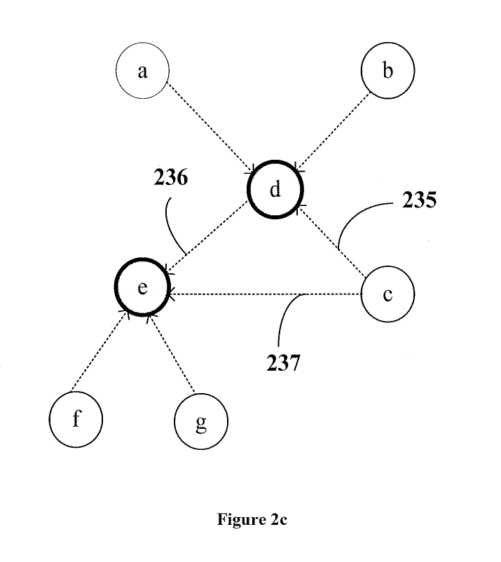

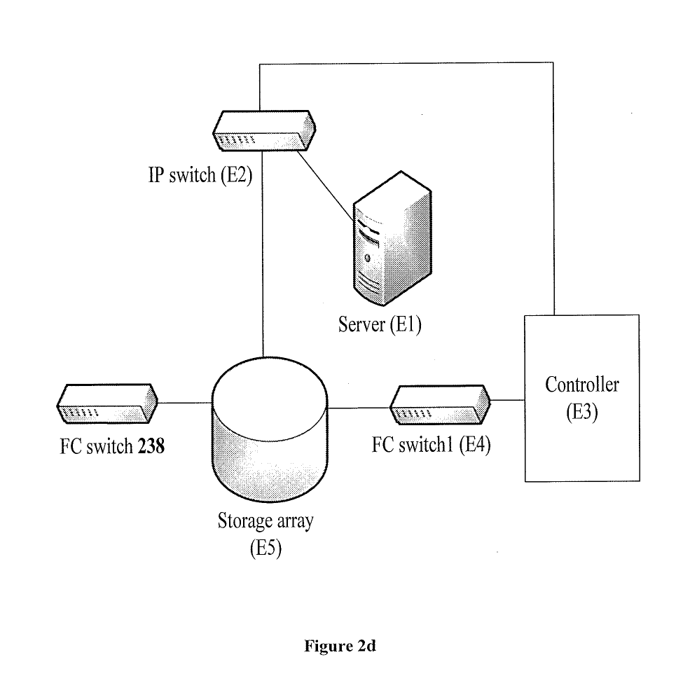

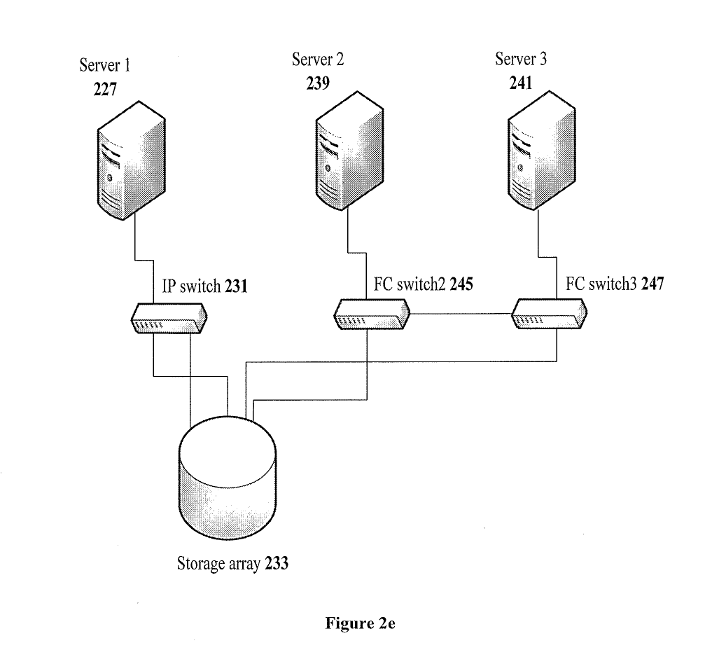

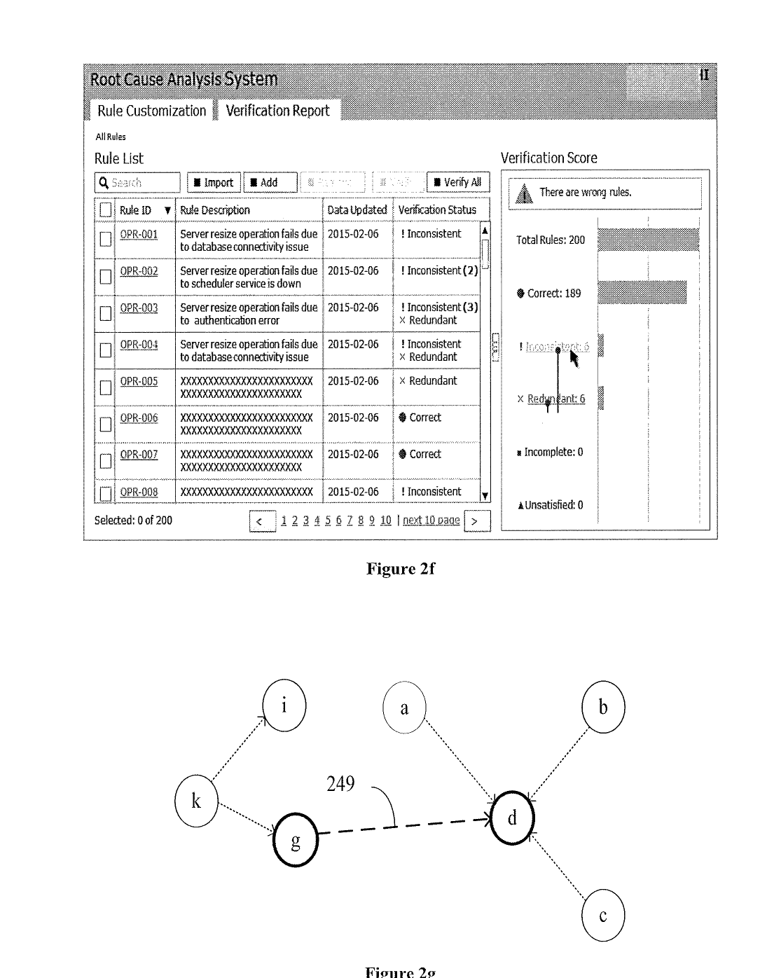

In one embodiment, the rules verification system 103 comprises a central processing unit (“CPU” or “processor”) 111, a memory unit 113, and a rules verification module 115. The rules verification system 103 may be a typical rules verification system as illustrated in FIG. 2a. The rules verification system 103 comprises the processing unit 111, the memory unit 113 and an I/O interface 201. The I/O interface 201 is coupled with the processing unit 111 and an I/O device. The I/O device is configured to receive inputs via the I/O interface 201 and transmit outputs for displaying in the I/O device via the I/O interface 201.

The rules verification system 103 comprises data 203 and modules 205. In one implementation, the data 203 and the modules 205 may be stored within the memory unit 113. In one example, the data 203 may include rules data 207, cloud topology data 209, verification report data 211, user inputs data 213 and other data 215. In one embodiment, the data 203 may be stored in the memory unit 113 in the form of various data structures. Additionally, the aforementioned data can be organized using data models, such as relational or hierarchical data models. The other data 215 may be also referred to as reference repository for storing recommended implementation approaches as reference data. The other data 215 may also store data, including temporary data and temporary files, generated by the modules 205 for performing the various functions of the rules verification system 103.

The modules 205 may include, for example, a receiving module 217, the rules verification module 115, a verification report generator module 219, a displaying module 221. The modules 205 may also comprise other modules 223 to perform various miscellaneous functionalities of the rules verification system 103. It will be appreciated that such aforementioned modules may be represented as a single module or a combination of different modules. The modules 205 may be implemented in the form of software, hardware and/or firmware.

In one embodiment, the receiving module 217 receives an input comprising predefined set of the one or more rules from the cloud database 105. In one example, the one or more rules indicate correlation of one or more events with one or more root causes defined. The one or more root causes are defined based on corresponding properties and constraints associated with the one or more events and the information associated with the one or more topologies of the cloud environment. The one or more rules are retrieved from the cloud database 105 by the rules verification system 103 and stored as the rules data 207. The one or more rules associated with the cloud environment are previously verified using static verification techniques known in the art and stored in the cloud database 105 for future use. The static verification technique may include, but not limited to, satisfiability modulo theories (SMT) solvers and constraint programming (CP) solvers. Upon receiving the input comprising the predefined set of the one or more rules, the receiving module 217 further receives dynamically the information associated with the one or more topologies of the cloud environment from the cloud database 105 and also the one or more user inputs to correct the one or more rules present in the input comprising predefined set of the one or more rules. The information associated with the one or more topologies of the cloud environment is stored as the cloud topology data 209. The one or more user inputs received are stored as the user inputs data 213. Any kind of modifications made to the one or more topologies of the cloud environment are updated dynamically to the cloud database 105 as well as the cloud topology data 209.

In one embodiment, the rules verification module 115 verifies the input comprising predefined set of the one or more rules with the dynamically received information associated with the one or more topologies of the cloud environment and the one or more user inputs, for determining compliance of one of the input comprising predefined set of the one or more rules and the information associated with the one or more topologies of the cloud environment with one or more property parameters. The one or more parameters may include, but not limited to, correctness, incorrectness, redundancy, completeness, incompleteness, consistency, inconsistency, satisfactory and non-satisfactory with respect to the input comprising predefined set of the one or more rules in accordance with the information associated with the one or more topologies of the cloud environment.

In one exemplary embodiment, correctness and incorrectness of the one or more rules is verified to confirm whether the one or more rules are correctly defined in accordance with the information associated with the one or more topologies of the cloud environment and to check whether connectivity paths in the one or more topologies of the cloud environment are correctly established. If the established connectivity paths are incorrect, then the root cause deduced is incorrect.

As an example, consider a cloud environment as shown in FIG. 2b where server 1 227 is connected to a storage array 233 through an Internet Protocol (IP) switch 231. But the one or more rules defined are in accordance with Fibre Channel (FC) switch belonging to a different cloud environment as shown in Table 1.

TABLE 1

| Rule ID | Rule Condition | Root cause for the event |
|---|---|---|
| 1 | Server 2 239 && FC switch2 245 | Storage array 233 |
| 2 | Server 2 239 && FC switch3 247 | Storage array 233 |
| 3 | Server 3 241 && FC switch3 247 | Storage array 233 |
| 4 | Server 3 241 && FC switch2 245 | Storage array 233 |

Therefore, the one or more rules are incorrectly defined with respect to the cloud environment, as FC switch is not present in the cloud environment. Incorrectness in the one or more rules can be rectified either by adding the one or more rules corresponding to the cloud environment as shown in FIG. 2b, i.e. defining the one or more rules with respect to server 1 227 and IP switch 231 or by selecting a different cloud environment relevant to the one or more rules defined in the Table 1.

As an example, consider connectivity paths as shown in FIG. 2c. The one or more rules with respect to FIG. 2c are shown below in Table 2.

TABLE 2

| Rule ID | Rule condition | Root cause for the event |
|---|---|---|
| 1 | a && b && c | d |
| 2 | f && g && c | e |

In the example, Rule ID 1 indicates events ‘a’, ‘b’ and resulting in root cause ‘d’ . . . Rule ID 2 indicates events ‘f’, ‘g’ and ‘c’ resulting in root cause ‘e’. In one scenario, consider there is a connectivity path 237 between events ‘c’ and ‘e’ and there is no connectivity path 235 between ‘c’ to ‘d’. However, if there exists a connectivity path 236 from ‘d’ to ‘e’, the connectivity path 237 becomes an incorrect path in accordance with the Rule ID 2, since the root cause pointed by ‘c’ is ‘e’ and the root cause pointed by ‘a’ and ‘b’ is ‘d’. Therefore this incorrect connectivity path 237 has to be rectified.

In one exemplary embodiment, redundancy of the one or more rules is verified to check if the one or more rules which are redundant resulting in the same root cause are present. In such cases, one or more redundant rules can be deleted. As an example, consider a cloud environment as shown in FIG. 2d comprising a server (E1), an IP switch1 (E2), a controller (E3), a FC switch1 (E4), a storage array (E5) and a FC switch 238. The one or more rules are defined with respect to the cloud environment as shown below in Table 3.

TABLE 3

| Rule ID | Rule condition | Root cause for the event |
|---|---|---|
| 1 | E1 & E2 & E3 & E4 | Failure in FC switch 238 |
| | & E5 | |
| 2 | E1 & E2 & E4 & E5 | Failure in FC switch 238 |

As mentioned in the Table 3, the events E1-E5 result in the root cause “failure in FC switch 238” and the events E1, E2, E4 and E5 also result in the root cause “failure in FC switch 238”. Hence, Rule ID 2 becomes redundant in accordance with Rule ID 1 as the events occurring in Rule ID 1 are already covered in Rule ID 2 and are also present in the same path in the corresponding topology of the cloud environment. Therefore, Rule ID 2 can be removed to eliminate redundant rules in the input comprising predefined set of the one or more rules.

In one exemplary embodiment, completeness of the one or more rules is verified to check if all of one or more resource components that can be traversed from one of the one or more resource components are covered in at least one of the one or more rules. As an example, consider a cloud environment as shown in FIG. 2e, comprising server 1 227, IP switch 231, a storage array 233, server 2 239, server 3 241, FC switch2 245 and FC switch3 247. The one or more rules for the cloud environment are defined in Table 1. But the one or more rules defined are incomplete since the one or more rules related to IP switch 231 are not defined in Table 1. Therefore, the one or more rules with respect to IP switch 231 have to be defined to ensure completeness of the one or more rules for the cloud environment. Further, completeness of the one or more rules is also verified to check availability of a connectivity path between the one or more resource components in the one or more topologies of the cloud environment, for every condition defined in the one or more rules. The one or more rules are said to be in conflict with the one or more topologies of the cloud environment, if there is a missing connectivity path between the one or more resource components in accordance with the condition defined in the one or more rules. As an example, consider the cloud environment as shown in FIG. 2e. According to the information associated with the topology of the cloud environment, if there exists a rule, ‘server 3 241’ && ‘IP switch 231’ having a root cause ‘storage array 233’, then the rule is said to be in conflict with the topology of the cloud environment as there exists no direct connectivity path between server 3 241 and IP switch 231. Therefore, either the rule is modified or the topology of the cloud environment is modified to rectify the conflict.

Furthermore, the one or more rules are verified to check for consistency i.e. the one or more rules are set to be inconsistent if for the same set of events two different root causes are given. The one or more rules are said to be inconsistent, if two different root causes are present for the same set of events. Furthermore, due to complexity in the input comprising predefined set of the one or more rules and the one or more topologies of the cloud environment, there might be occurrence of cycles and self-loops in the one or more rules in accordance with the one or more topologies of the cloud environment. Occurrence of cycle causes the one or more rules to be in a locked state, wherein the one or more events involved in the cycle are referred to each other as the root cause of those events without deducing original root cause of the events. Similarly, occurrence of a self-loop causes the one or more rules to refer its own event as the root cause of that event without deducing the original root cause of that event. Therefore, the one or more rules are verified to rectify self-loop and cyclic failures in the input comprising predefined set of the one or more rules and the information associated with the one or more topologies of the cloud environment.

Upon performing the verification by the rules verification module 115, a verification report is generated by the verification report generator module 219. The generated verification report is stored as the verification report data 211. The verification report data 211 comprises output verified result set of the one or more rules, corresponding verification status information of each of the one or more rules of the output verified result set and a verification score determined for the output verified result set. The verification status of the output verified result set indicates at least one of consistent, complete, incomplete, inconsistent, redundant, correct, incorrect, satisfactory and non-satisfactory. The verification score is indicative of total count of correct and incorrect rules of the one or more rules of the output verified result set.

FIG. 2f shows an exemplary verification report generated by the verification report generator module 219. The exemplary verification report comprises the rule ID, rule description, last updation date of the data present in the verification report, verification status and verification score. The verification score indicates, total number of rules verified as 200 i.e 200 number of rules has been verified by the rules verification module, total number of correct rules in the output verified result set as 189, total number of inconsistent rules as 6, total number of redundant rules as 6, total number of incomplete rules as 0 and total number of unsatisfied rules as 0. Therefore, the verification score infers that totally 189 rules in the output verified result set are correct out of 200 verified rules.

In one embodiment, the display module 221 displays the verification report to the user. One or more suggestions based on the verification report are given to the user. As an example, the one or more suggestions provided to the user may be, adding conditions to the one or more rules, removing the one or more rules, merging the one or more rules, modifying the one or more rules, making changes to the topology etc. The user performs one or more actions on the output verified result set based on the suggestions given through the verification report. The one or more actions may be at least one of adding, updating, modifying, ignoring and deleting at least one of the one or more rules in the output verified result set or the information associated with the one or more topologies of the cloud environment.

As an example, consider a cloud environment as shown in FIG. 2g. The one or more rules in accordance with the cloud environment are as shown below in Table 4. Rule ID 1 indicates events ‘a’, ‘b’ and ‘c’ resulting in the root cause ‘d’. Rule ID 2 indicates events ‘i’ and ‘k’ resulting in the root cause ‘g’. The rules verification system 103 provides a merging suggestion to the user, wherein, the topology of the cloud environment is modified by adding a new connectivity path 249 between events ‘g’ and ‘d’ in accordance with the merging suggestion provided by the rules verification system 103. Therefore, Rule ID 3 is added as the new rule in accordance with the merging suggestion that indicates events ‘a’, ‘b’, ‘c’, ‘i’ and ‘k’ resulting in the root cause ‘d’.

TABLE 4

| Rule ID | Rule condition | Root cause of the event |
|---|---|---|
| 1 | a && b && c | d |
| 2 | i && k | g |
| 3 | a && b && c | d |
| | && i && k | |

The verification process in accordance with the dynamic information associated with the one or more topologies of the cloud environment and the one or more user inputs is iteratively performed until the user is satisfied with the generated verification report, i.e. the verification report should indicate 100% verification score.

Thus, the present disclosure verifies the one or more rules in accordance with the information associated with the one or more topologies of the cloud environment and the one or more user inputs to provide the output verified result set. The output verified result set thus obtained is given as an input to the root cause analysis system 107 to deduce the root cause of a failure in the cloud environment.

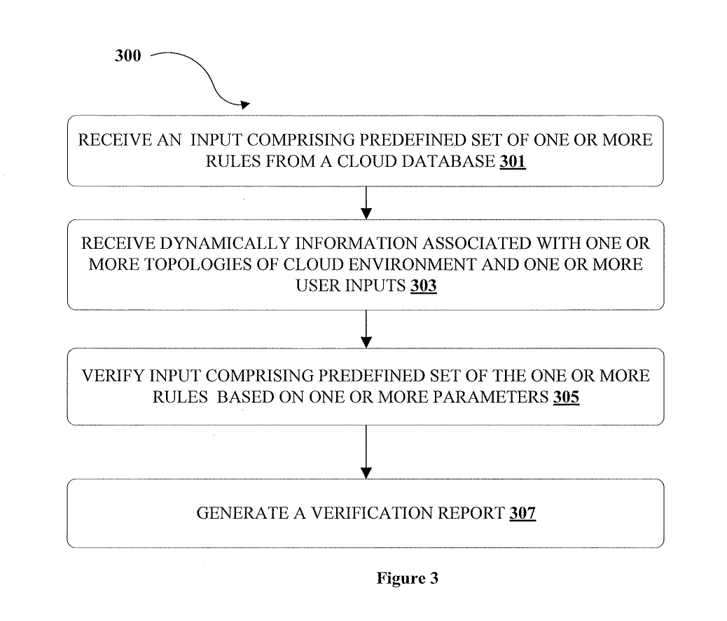

FIG. 3 illustrates a flowchart of an exemplary method for verifying one or more rules of a root cause analysis system in a cloud environment in accordance with some embodiments of the present disclosure.

As illustrated in FIG. 3, the method 300 comprises one or more blocks implemented by the processing unit 111 for verifying one or more rules of a root cause analysis system 107 in a cloud environment. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

At block 301, receive input comprising predefined set of the one or more rules. In one embodiment, the rules verification system 103 receives the input comprising predefined set of the one or more rules from the cloud database 105. The received one or more rules indicate correlation of one or more events with one or more root causes defined based on corresponding properties and constraints associated with the one or more events and information associated with one or more topologies of the cloud environment. The one or more rules present in the input comprising predefined set of the one or more rules are pre-verified using static verification techniques.

At block 303, receive dynamically the information associated with the one or more topologies of the cloud environment and one or more user inputs. In one embodiment, the rules verification system 103 receives the information associated with the one or more topologies of the cloud environment, retrieved from the cloud database 105. In another embodiment, the rules verification system 103 receives one or more user inputs to correct the errors detected in the input comprising predefined set of the one or more rules.

At block 305, verify input comprising predefined set of the one or more rules based on one or more property parameters. In one embodiment, the rules verification system 103 verifies the input comprising predefined set of the one or more rules with the information associated with the one or more topologies of the cloud environment and the one or more user inputs, for determining compliance of one of the input comprising predefined set of the one or more rules and the information associated with the one or more topologies of the cloud environment with one or more property parameters. The one or more property parameters may include, but not limited to, completeness, incompleteness, correctness, incorrectness, consistency, inconsistency, redundancy, satisfactory and non-satisfactory associated with the one or more rules in accordance with the information associated with the one or more topologies of the cloud environment. In one embodiment, correctness and incorrectness of the one or more rules is verified to confirm whether the one or more rules are correctly defined in accordance with the information associated with the one or more topologies of the cloud environment and to check whether connectivity paths in the one or more topologies of the cloud environment are correctly established, as explained above using FIG. 2b and FIG. 2c. If the connectivity paths are incorrect, then the root cause deduced is also incorrect. In one embodiment, redundancy of the one or more rules is verified to check if the one or more rules which are redundant resulting in the same root cause are present, as explained above using FIG. 2d. In such cases, one or more redundant rules can be deleted. In one embodiment, completeness and incompleteness of the one or more rules is verified to check if all of the one or more resource components, that can be traversed from one of the one or more resource components are covered in the one or more rules, as explained above using FIG. 2e. Further, the one or more rules are also verified to check for consistency, inconsistency and conflict in accordance with the information associated with one or more topologies of the cloud environment. The one or more rules are said to be inconsistent, if two different root causes are present for the same set of events. Furthermore, due to complexity in the input comprising predefined set of the one or more rules and the information associated with the one or more topologies of the cloud environment, there might be occurrence of cycles and self-loops in the one or more rules in accordance with the information associated with the one or more topologies of the cloud environment. The one or more rules are said to be in conflict with the information associated with the one or more topologies of the cloud environment, if there is a missing connectivity path between the one or more resource components corresponding to the condition defined in the one or more rules. The failures detected corresponding to the one or more parameters are rectified by at least one of the two embodiments. In one embodiment, the one or more rules are modified in accordance with the information associated with the one or more topologies of the cloud environment. In another embodiment, the one or more topologies of the cloud environment are modified with respect to the condition defined in the one or more rules. At block 307, generate a verification report. In one embodiment, the rules verification system 103 generates a verification report. The verification report comprises output verified result set of the one or more rules, corresponding verification status information of each of the one or more rules of the output verified result set and a verification score determined for the output verified result set. The verification status of the output verified result set indicates at least one of consistent, inconsistent, redundant, correct, incorrect, satisfactory and non-satisfactory. The verification score determines the number of correct and incorrect rules among total number of the one or more rules.

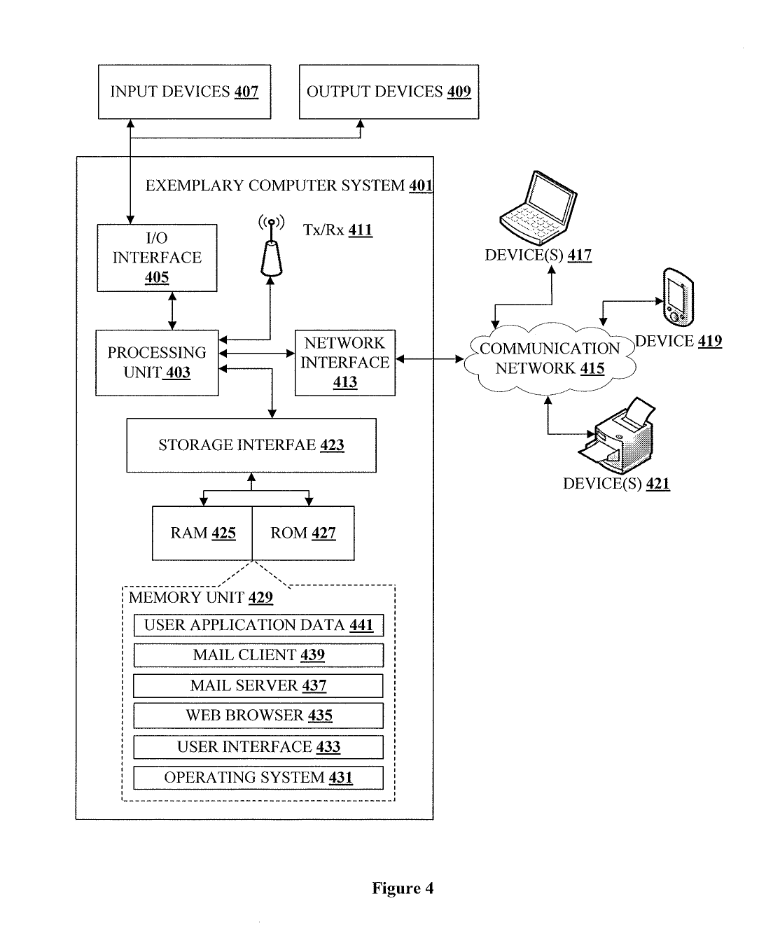

FIG. 4 is a block diagram of an exemplary computer system for implementing embodiments consistent with the present disclosure.

Variations of computer system 401 may be used for implementing all the computing systems that may be utilized to implement the features of the present disclosure. Computer system 401 may comprise a central processing unit (“CPU” or “processor”) 403. Processor 403 may comprise at least one data processor for executing program components for executing user- or system-generated requests. The processor 403 may include specialized processing units such as integrated system (bus) controllers, memory management control units, floating point units, graphics processing units, digital signal processing units, etc. The processor 403 may include a microprocessor, such as AMD Athlon, Duron or Opteron, ARM's application, embedded or secure processors, IBM PowerPC, Intel's Core, Itanium, Xeon, Celeron or other line of processors, etc. The processor 403 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 403 may be disposed in communication with one or more input/output (I/O) devices via I/O interface 405. The I/O interface 405 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 405, the computer system 401 may communicate with one or more I/O devices. For example, the input device 407 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 409 may be a printer, fax machine, video display (e.g., cathode ray tube (CRT), liquid crystal display (LCD), light-emitting diode (LED), plasma, or the like), audio speaker, etc. In some embodiments, a transceiver 411 may be disposed in connection with the processor 403. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 403 may be disposed in communication with a communication network 415 via a network interface 413. The network interface 413 may communicate with the communication network 415. The network interface 413 may employ connection protocols including, without limitation, direct connect, Ethernet (e.g., twisted pair 10/40/400 Base T), transmission control protocol/internet protocol (TCP/IP), token ring, IEEE 802.11a/b/g/n/x, etc. The communication network 415 may include, without limitation, a direct interconnection, local area network (LAN), wide area network (WAN), wireless network (e.g., using Wireless Application Protocol), the Internet, etc. Using the network interface 413 and the communication network 415, the computer system 401 may communicate with devices 417, 419, and 421. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 403 may be disposed in communication with one or more memory devices (e.g., RAM 425, ROM 4Error! Reference source not found.27, etc.) via a storage interface 423. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 429 may store a collection of program or database components, including, without limitation, an operating system 4Error! Reference source not found.31, user interface application 4Error! Reference source not found.33, web browser 435, mail server 437, mail client 439, user/application data 441 (e.g., any data variables or data records discussed in this disclosure), etc. The operating system 431 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 433 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 435 stored program component. The web browser may be a hypertext viewing application, such as Microsoft Internet Explorer, Google Chrome, Mozilla. Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 437 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 439 stored program component. The mail client may be a mail viewing application, such as Apple Mail, Microsoft Entourage, Microsoft Outlook, Mozilla Thunderbird, etc.

In some embodiments, computer system 401 may store user/application data 441, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, strict, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As described above, the modules 205, amongst other things, include routines, programs, objects, components, and data structures, which perform particular tasks or implement particular abstract data types. The modules 205 may also be implemented as, signal processor(s), state machine(s), logic circuitries, and/or any other device or component that manipulate signals based on operational instructions. Further, the modules 205 can be implemented by one or more hardware components, by computer-readable instructions executed by a processing unit, or by a combination thereof.

The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

### REFERRAL NUMERALS

| Reference Number | Description |
|---|---|
| 103 | Rules verification system |
| 105 | Cloud database |
| 107 | Root cause analysis system |
| 109 | Network |
| 111 | Processing unit |
| 113 | Memory unit |
| 115 | Rules verification module |
| 201 | I/O interface |
| 203 | Data |
| 205 | Modules |
| 207 | Rules data |
| 209 | Cloud topology data |
| 211 | Verification report data |
| 213 | User inputs data |
| 215 | Other data |
| 217 | Receiving module |
| 219 | Verification report generator module |
| 221 | Displaying module |
| 223 | Other modules |
| 227 | Server 1 |
| 231 | IP switch |
| 233 | Storage array |
| 238 | FC switch |
| 239 | Server 2 |
| 241 | Server 3 |
| 245 | FC switch2 |
| 247 | FC switch3 |

We claim:

1. A method for verifying one or more rules of a root cause analysis system in a cloud environment, the method comprising:
receiving, by a rules verification system, an input comprising predefined set of the one or more rules from a cloud database;
receiving dynamically, by the rules verification system, information associated with one or more topologies of the cloud environment from the cloud database and one or more user inputs on the input comprising predefined set of the one or more rules;
verifying, by the rules verification system, the input comprising predefined set of the one or more rules with the information associated with the one or more topologies of the cloud environment and the one or more user inputs, for determining compliance of one of the input comprising predefined set of the one or more rules and the information associated with the one or more topologies of the cloud environment with one or more property parameters; and
generating, by the rules verification system, a verification report comprising output verified result set of the one or more rules, a corresponding verification status information of each of the one or more rules of the output verified result set and a verification score determined for the output verified result set.

2. The method as claimed in claim 1 further comprises providing one or more suggestions to the user based on the verification report generated, for enabling the user to perform one or more actions on at least one of the output verified result set and the information associated with the one or more topologies of the cloud environment.

3. The method as claimed in claim 2, wherein the one or more actions comprises at least one of adding, updating, modifying, ignoring and deleting at least one of the one or more rules and the information associated with the one or more topologies of the cloud environment.

4. The method as claimed in claim 1, wherein the one or more rules indicate correlation of one or more events with one or more root causes defined based on corresponding properties and constraints associated with the one or more events and the information associated with the one or more topologies of the cloud environment.

5. The method as claimed in claim 1, wherein the one or more property parameters comprises at least one of completeness, incompleteness, correctness, incorrectness, consistency, inconsistency, redundancy, satisfactory and non-satisfactory, associated with the one or more rules in accordance with the information associated with the one or more topologies of the cloud environment.

6. The method as claimed in claim 1, wherein the verification status information of the output verified result set comprises at least one of consistent, inconsistent, redundant, correct, incorrect, complete, incomplete, satisfactory and non-satisfactory.

7. A rules verification system for verifying one or more rules of a root cause analysis system in a cloud environment, the system comprising:
a processing unit; and
a memory unit communicatively coupled to the processing unit, wherein the memory unit stores the processing unit-executable instructions which, on execution causes the processing unit to:
receive an input comprising predefined set of the one or more rules from a cloud database;
receive dynamically information associated with one or more topologies of the cloud environment from the cloud database and one or more user inputs on the input comprising predefined set of the one or more rules;
verify the input comprising predefined set of the one or more rules with the information associated with the one or more topologies of the cloud environment and the one or more user inputs, for determining compliance of one of the input comprising predefined set of the one or more rules and the information associated with the one or more topologies of the cloud environment with one or more property parameters; and
generate a verification report comprising output verified result set of the one or more rules, a corresponding verification status information of each of the one or more rules of the output verified result set and a verification score determined for the output verified result set.

8. The rules verification system as claimed in claim 7, wherein the processing unit is further configured to provide one or more suggestions to the user based on the verification report generated, for enabling the user to perform one or more actions on at least one of the output verified result set and the one or more topologies of the cloud environment.

9. The rules verification system as claimed in claim 8, wherein the one or more actions comprises at least one of adding, updating, modifying, ignoring and deleting at least one of the one or more rules and the information associated with the one or more topologies of the cloud environment.

10. The rules verification system as claimed in claim 7, wherein the one or more rules indicate correlation of one or more events with one or more root causes defined based on corresponding properties and constraints associated with the one or more events and the information associated with the one or more topologies of the cloud environment.

11. The rules verification system as claimed in claim 7, wherein the one or more property parameters comprises at least one of completeness, incompleteness, correctness, incorrectness, consistency, inconsistency, redundancy, satisfactory and non-satisfactory, associated with the one or more rules in accordance with the information associated with the one or more topologies of the cloud environment.

12. The rules verification system as claimed in claim 7, wherein the verification status information of the output verified result set comprises at least one of consistent, inconsistent, redundant, correct, incorrect, complete, incomplete, satisfactory and non-satisfactory.

13. A non-transitory computer readable medium including instructions stored thereon that when processed by at least one processing unit cause a rules verification system to perform operations comprising:
receiving an input comprising predefined set of the one or more rules from a cloud database;
receiving dynamically information associated with one or more topologies of the cloud environment from the cloud database and one or more user inputs on the input comprising predefined set of the one or more rules;
verifying the input comprising predefined set of the one or more rules with the information associated with the one or more topologies of the cloud environment and the one or more user inputs, for determining compliance of one of the input comprising predefined set of the one or more rules and the information associated with the one or more topologies of the cloud environment with one or more property parameters; and
generating a verification report comprising output verified result set of the one or more rules, a corresponding verification status information of each of the one or more rules of the output verified result set and a verification score determined for the output verified result set.
